(19) United States
(12) Patent Application Publication
(10) Pub. No.: US 2024/0191827 A1
(43) Pub. Date: Jun. 13, 2024

(54) WIRELINE THREAD PROTECTION SYSTEM WITH SELF-ALIGNING BIT AND METHOD OF USING SAME

(71) Applicant: GR Energy Services Management, LP, Sugar Land, TX (US)

(72) Inventors: Cameron Michael Bryant, Sugar Land, TX (US); Jeremy Quentin Logan, Katy, TX (US); James William ANTHONY, Missouri City, TX (US); Joshua Blake Howk, Kingwood, TX (US)

(21) Appl. No.: 18/287,005

(22) PCT Filed: Apr. 15, 2022
(86) PCT No.: PCT/US22/25069

§ 371 Date: Oct. 14, 2023

Related U.S. Application Data
(60) Provisional application No. 63/176,260, filed on Apr. 17, 2021.

(51) Int. Cl. F16L 57/00; E21B 17/00

(52) U.S. Cl. CPC F16L 57/005; E21B 17/006

(57) ABSTRACT

A thread protection system for a wellbore tubular includes a thread protector and a self-aligning bit. The thread protector has an insert portion at one end and a drive portion at an opposite end. The insert portion is engageable with an end of the wellbore tubular. The drive portion has a central cavity axially positioned about the thread protector and a plurality of pockets radially disposed about the central cavity. The self-aligning bit includes a platform with a central hub and a plurality of fingers extending perpendicularly from a driven side of the platform. The fingers are radially disposed about the central hub. The central hub is slidingly receivable in the central cavity. Each finger has a tapered tip slidingly receivable into the plurality of pockets. The self-aligning bit is rotationally drivable by a driver whereby the thread protector is removably connectable to the wellbore tubular.

### CROSS-REFERENCE TO RELATED APPLICATIONS

The application claims the benefit of U.S. Provisional Patent Application No. 63/176,260 filed on Apr. 17, 2021, the entire contents of which is hereby incorporated by reference herein to the extent not inconsistent with the present disclosure.

### BACKGROUND

The present disclosure relates generally to oilfield technology. More specifically, the present disclosure relates to devices for protecting oilfield equipment, such as wireline (or other) tubulars.

Wellsite operations are performed to locate and access subsurface targets, such as valuable hydrocarbons. Drilling equipment is positioned at the surface and downhole drilling tools are advanced into the subsurface formation to form wellbores. Once drilled, casing may be inserted into the wellbore and cemented into place to complete the well. Once the well is completed, production tubing may be deployed through the casing and into the wellbore to produce fluid to the surface for capture.

Various wellsite equipment may be used at a wellsite for performing wellsite operations. Wellsite equipment, such as downhole tools, may be deployed into the earth to perform various procedures, such as measurement, perforation, injection, plugging, etc. Examples of wellsite equipment are provided in US Patent/Application Nos. 1020/0024935; 10507433; 10,036,236; 2020/0072029; US2020/0048996; 2016/0115753; 2020/0277837; 20190376775; 20190330947; 20190242222; 20190234189; 10309199; 20190127290; 20190086189; 20180499239; 20180424260; 9915513; 20180038208; 9822618; 9605937; 20170074078; 9581422; 20170030693; 20160356132; 20160061572; 8960093; 20140033939; 8267012; 6520089; 20160115753; 20190178045; and 10365079, the entire contents of which is hereby incorporated by reference herein to the extent not inconsistent with the present disclosure.

Downhole tools are made of multiple components. Examples of downhole tools are provided in U.S. Pat. Nos. 7,896,083; 9,206,675; 9,581,422; 1,749,162; 2,092,535; 4,553,567; 5,048,571; 5,628,601; 6,142,186; 6,196,270; 7,281,546; 20110203698; 20110265904; 20130105028; and 20190375564, the entire contents of which is hereby incorporated by reference herein to the extent not inconsistent with the present disclosure. Downhole tools and their components may be pre-assembled offsite and delivered to wellsites, or assembled at the wellsite.

Despite the advancements in wellsite technology, there remains a need for techniques for reliably protecting downhole tools during storage and/or transport. The present disclosure is directed at providing such needs.

### SUMMARY

In at least one aspect, the disclosure relates to a thread protection system for a wellbore tubular. The thread protection system comprises a thread protector and a self-aligning bit. The thread protector has an insert portion at one end and a drive portion at an opposite end. The insert portion is engageable with an end of the wellbore tubular. The drive portion has a central cavity axially positioned about the thread protector and a plurality of pockets radially disposed about the central cavity. The self-aligning bit comprises a platform with a central hub and a plurality of fingers extending perpendicularly from a driven side of the platform. The plurality of fingers are radially disposed about the central hub. The central hub is slidingly receivable in the central cavity. The plurality of finger have tapered tips slidingly receivable into the plurality of pockets. The self-aligning bit is rotationally drivable by a driver whereby the thread protector is removably connectable to the wellbore tubular.

In another aspect, the disclosure relates to a thread protection system for a wellbore tubular. The thread protection system comprises a threat protector and an alignable drive tool. The thread protector has an insert portion at one end and a drive portion at an opposite end. The insert portion is engageable with an end of the wellbore tubular. The drive portion has a central cavity axially positioned about the thread protector and a plurality of pockets radially disposed about the central cavity. The alignable drive tool comprises a self-aligning bit and a driver. The self-aligning bit comprises a platform with a central hub and a plurality of fingers extending perpendicularly from a driven side of the platform. The plurality of fingers are radially disposed about the central hub. The central hub is slidingly receivable in the central cavity. The plurality of finger has tapered tips slidingly receivable into the plurality of pockets. The driver is rotationally connectable to the self-aligning bit and drivable thereby whereby the thread protector is removably connectable to the wellbore tubular. While the central hub is positioned in the central cavity and the self-aligning bit advances into the drive portions, the tapered tips of the plurality of fingers slidingly engage the plurality of pockets and center the plurality of fingers within the plurality of pockets.

In yet another aspect, the disclosure relates to a method of protecting a wellbore tubular. The method comprises inserting an insert portion of a thread protector into an end of the wellbore tubular such that a drive portion of the thread protector is positioned about the end of the wellbore tubular, the drive portion having a central cavity with a plurality of pockets radially disposed about the central cavity; inserting a self-aligning bit into the drive portion of the thread protector by: slidingly receiving a central hub of the self-aligning bit into the central cavity; and slidingly receiving a plurality of fingers of the self-aligning bit into the plurality of pockets; and removably connecting the thread protector to the wellbore tubular by rotationally driving the self-aligning bit such that threads on the insert portion of the self-aligning bit matingly engage corresponding threads of the end of the wellbore tubular.

In at least one aspect, the present disclosure relates to a thread protection system for a wellbore tubular. The thread protection system includes a thread protector and an alignment drive tool. The thread protector comprises an insert portion and a drive portion. The insert portion is threadedly insertable into an end of the wellbore tubular. The drive portion extends from the end of the wellbore tubular. The drive portion has a central cavity and a plurality of pockets radially disposed about the central cavity. The alignable drive tool comprises a self-aligning bit and a driver. The self-aligning bit is engageable with the drive portion of the thread protector. The self-aligning bit has a central hub with a plurality of fingers radially disposed about the central hub. The central hub is slidingly receivable in the central cavity. The plurality of finger has tapered tips slidingly receivable into the plurality of pockets. The driver comprises a motor to drive the self-aligning bit. While the central hub is positioned in the central cavity and the self-aligning bit advances into the drive portions, the tapered tips of the plurality of fingers slidingly engage the plurality of pockets and center the plurality of fingers within the plurality of pockets.

The present disclosure also relates to a thread protector as described herein, and to an alignable drive tool as described herein. The present disclosure also relates to a method of protecting a wellbore tubular comprising installing the thread protector in the wellbore tubular using the alignable drive tool.

This Summary is not intended to be limiting and should be read in light of the entire disclosure including text, claims and figures herein.

### BRIEF DESCRIPTION OF THE DRAWINGS

So that the above recited features and advantages of the present disclosure can be understood in detail, a more particular description of the invention, briefly summarized above, may be had by reference to the embodiments thereof that are illustrated in the appended drawings. The appended drawings illustrate example embodiments and are, therefore, not to be considered limiting of its scope. The figures are not necessarily to scale and certain features, and certain views of the figures may be shown exaggerated in scale or in schematic in the interest of clarity and conciseness.

FIG. 1 is a schematic diagram depicting a wellsite showing transport of a thread protection system and tubulars to the wellsite, the tubulars having thread protectors therein.

FIGS. 2A and 2B are schematic views of the tubular with the thread protectors installed therein, and an alignable drive tool in a disengaged and an engaged position, respectively, with the thread protector.

FIG. 3 is an exploded view of the tubular, the thread protectors, and the alignable drive tool.

FIGS. 4A-4F are front perspective, rear perspective, front end, side, rear end, and cross-sectional views, respectively, of the thread protector.

FIG. 5 is a perspective view of the alignable drive tool with a self-aligning bit.

FIGS. 6A-6E are perspective, front end, side, cross-sectional, and rear end views of the self-aligning bit.

FIGS. 7A and 7B are perspective views of the thread protector and the self-aligning bit in the disengaged and the engaged position, respectively.

FIGS. 8A-8C are perspective, side, and end views, respectively, of another thread protector.

FIG. 9 is a flow chart of a method of protecting a wellbore tubular.

### DETAILED DESCRIPTION

The description that follows includes exemplary apparatus, methods, techniques, and/or instruction sequences that embody techniques of the present subject matter. However, it is understood that the described embodiments may be practiced without these specific details.

The present disclosure relates to a thread protection system including a thread protector and an alignable drive tool. The thread protector is positionable about a wellbore tubular (e.g., wireline housings) for protecting such tubular. The alignable drive tool is usable for installing and removing the thread protector from the tubular.

The ends of the tubular may be prone to damage (e.g., scraping, bending, deformation, or other alteration) due to use and/or environmental conditions, such as impact, wear, heat, pressure, etc. Such damage may occur during storage, transportation, and/or at other times. The ends of the tubular may also have features (e.g., shoulders, keyways, threads, rings, or other structures) installed by processes, such as welding, machining, bonding, etc. Manufacture of the tubular and/or the features of the tubular may define weaknesses in the ends of the tubular which may encourage damage to the ends of the tubular.

The tubular may also have threaded ends for connection to adjacent tubulars. The thread protector may be positioned about the threaded ends of the tubular to provide protection and support. The alignable drive tool may include a self-aligning bit shaped to engage and rotationally drive the thread protector into and out of the threaded ends of the tubular. The thread protector has a receptacle in an end thereof shaped to receive the self-aligning bit. The self-aligning bit may be placed in any position about the receptacle and rotated during advancement until full alignment is achieved, thereby facilitating and speeding up alignment between the thread protector and the alignable drive tool during mating.

The thread protection system, thread protector, alignable drive tool, and/or methods described herein are also intended to provide one or more of the following, among others: protection during transport and storage, efficient installation and removal, reduced installation and removal time, operability at high speeds (e.g., rpms), interlocking and self-orienting components, facilitated alignment during installation/removal, reduced thread protector installation time, facilitated installation and/or mating of protected tubulars, reliable threaded connection of protected tubulars, protection of tubular shape and threading of protected tubulars, reduced maintenance and repair costs, use with a variety of tubulars, enhanced transportability of tubulars, use on or offsite, etc.

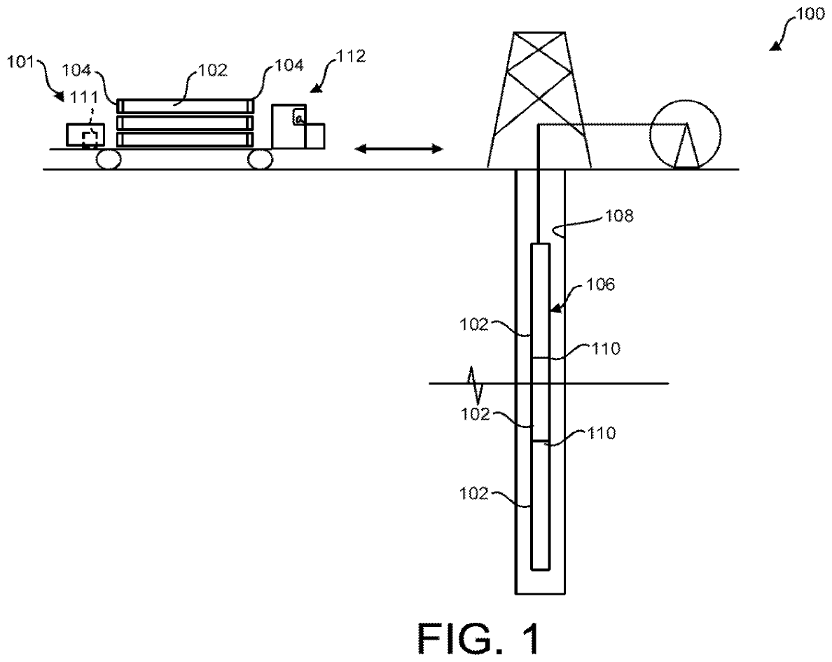

FIG. 1 is a schematic diagram depicting a wellsite 100 showing transport of a thread protection system 101 and tubulars 102 to the wellsite 100, the tubulars 102 having thread protectors 104 therein. The wellsite has a wireline tool 106 positioned in a wellbore 108. The wireline tool 106 includes a series of tubular 102 connected end to end to form the wireline tool 106. The tubular 102 as described herein is a wellbore tubular having a metal, tubular-shaped (cylindrical) body with a passage extending linearly therethrough. The tubulars 102 may be hollow housings used for containing downhole components (not shown) for performing downhole functions. The passages may extend through the tubulars 102 for passage of fluids, wiring, or other materials therethrough.

The tubular 102 as described herein also has threaded ends 110 at each end thereof for mated connection to an adjacent tubular 102. The threaded ends 110 as described herein are mated threads matingly connectable to the threaded ends of an adjacent tubular or other component (e.g., sleeve, coupling, etc.) with corresponding threads. While the tubular 102 described in the examples herein have a specific geometry and construction for use with the thread protectors 104, it will be appreciated by one of skill in the art that such geometry and construction may vary.

The tubulars 102 may be transported to the wellsite 100 and connected together for use downhole in the wellbore 108. As shown in FIG. 1, the tubulars 102 may be transported to and/or from the wellsite 100 by a transporter (e.g., truck, train, cart, etc.) 112. The transporter 112 may also carry the thread protection system 101 for use with the tubulars 102. The thread protection system 101 includes the thread protectors 104 and an alignable drive tool 111. During transport, the threaded ends 110 of the tubulars 102 may be protected by positioning of the thread protectors 104 about the threaded ends 110 using the alignable drive tool 111 as is described further herein.

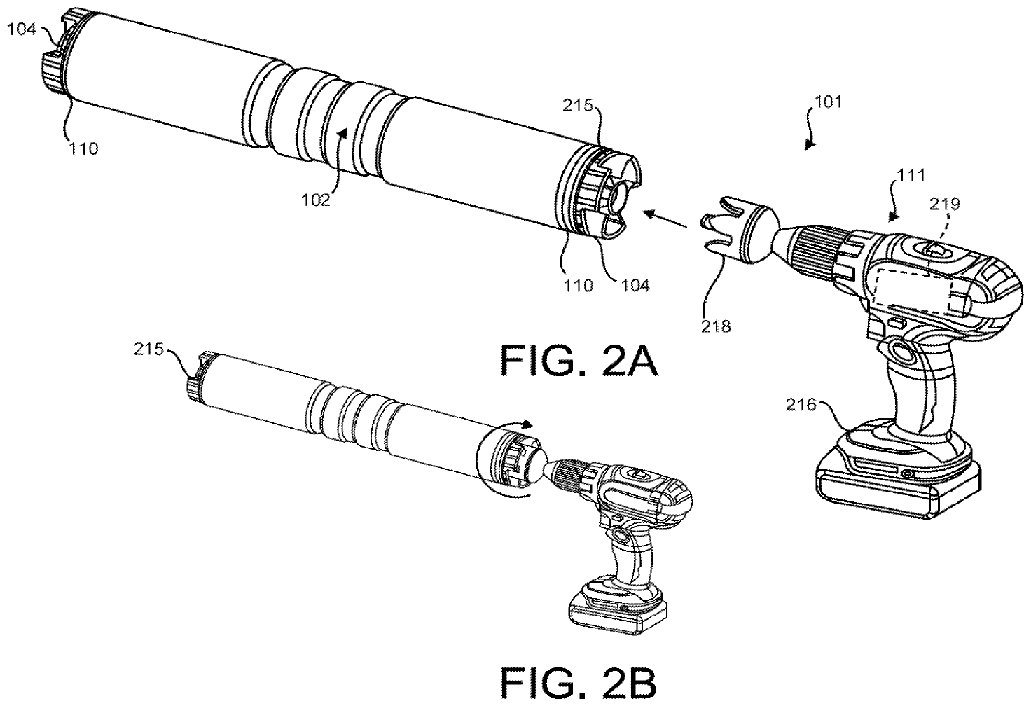

FIGS. 2A, 2B, and 2C show various views of the thread protection system 101 in use with the tubular 102. FIGS. 2A and 2B are schematic views of the tubular 102 with thread protectors 104 installed therein, and the alignable drive tool 111 in the disengaged and engaged position, respectively, with the thread protector 104. As shown in these views, the tubular 102 has a cylindrical shape with openings 215 at the threaded ends 110. The thread protectors 104 extend into the openings 215 of the threaded ends 110 for protection thereof.

As also shown in FIGS. 2A and 2B, the alignable drive tool 111 is engageable with the thread protector 104 for rotationally driving the thread protector 104. The alignment drive tool 111 may be used to rotate the thread protectors 104 as they are advanced into and/or retracted from a corresponding one of the threaded ends 110 of the tubular 102. Such advancement and retraction may involve driving the thread protectors 104 along threads of the tubular 102 as is described further herein.

The alignable drive tool 111 includes a driver 216 and a self-aligning bit 218. As demonstrated by the example of FIGS. 2A and 2B, the driver 216 may be in the form of a drill capable of axially and rotationally driving the self-aligning bit 218. The driver 216 may also be, for example, a hand-held unit carried by an operator (not shown) for supporting and driving the self-aligning bit 218. The hand-held version of the driver 216 may have a motor 219 for rotating the self-aligning bit 218 while the operator applies an axial force to advance the self-aligning bit 218 against the thread protector 104. Other forms of drivers may have automatic and/or manual components capable of rotational and/or axial movement of the self-aligning bit.

The self-aligning bit 218 may be moved from the disengaged position of FIG. 2A to the engaged position of FIG. 2B. The self-aligning bit 218 is matingly engageable with the thread protector 104. Once engaged, the self-aligning bit 218 is driven by the driver 216 for insertion and removal of the thread protector 104. To facilitate use of the alignment drive tool 111 with the thread protector 104, the self-aligning bit 218 is shaped for self-alignment with the thread protector 104 as the self-aligning bit 218 is moved into engagement with the thread protector 104 as is described further herein.

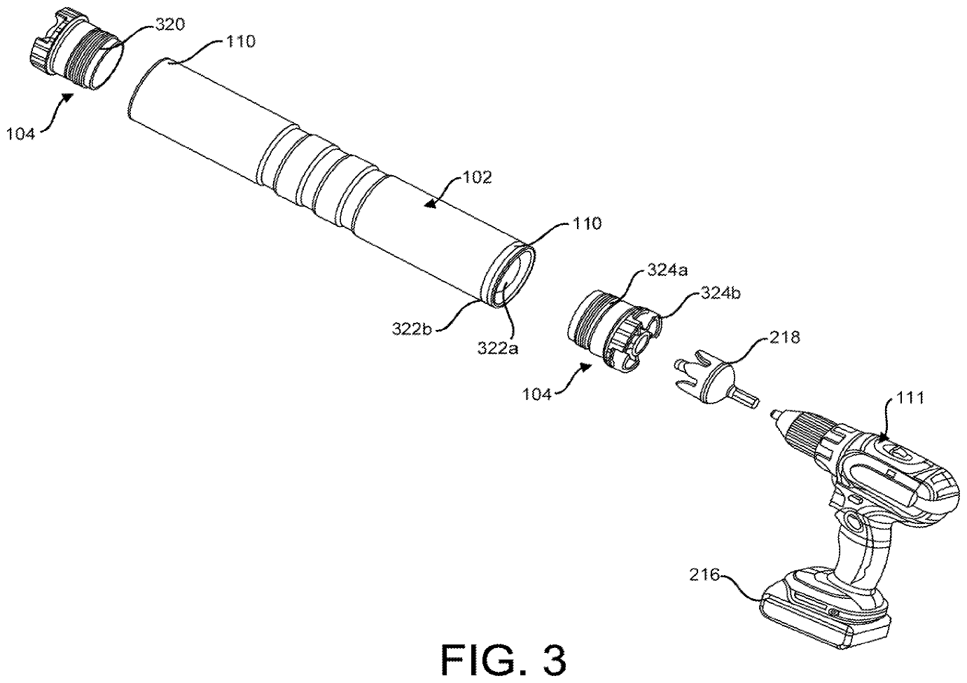

FIG. 3 is an exploded view of the tubular 102, the thread protectors 104, and the alignment drive tool 111. As shown in this view, the tubular 102 may be provided with internal threads 322a at each end thereof. The threaded ends 110 may also be provided with shoulders (or steps) 322b along an inner and/or outer surface of the tubular 102, such as those shown as extending radially about the threaded ends 110.

The thread protectors 104 are shaped for insertion into each of the threaded ends 110 of the tubular 102. Each of the thread protectors 104 has an insert portion 324a at one end and a drive portion 324b at an opposite end. The insert portion 324a is insertable into the threaded end 110 of the tubular 102. The insert portion 324a may have insert threads 320 corresponding to the internal threads 322a of the threaded ends 110 of the tubular 102. The drive portion 324b extends from the threaded end 110 of the tubular 102 when the thread protector 104 is inserted into the tubular 102 (see, e.g., FIG. 2B).

As also shown in FIG. 3, the self-aligning bit 218 is removable from the driver 216. The self-aligning bit 218 may be replaceable for maintenance, and/or interchangeable with other bits to provide different geometries or types of bits capable of operating with various thread protectors.

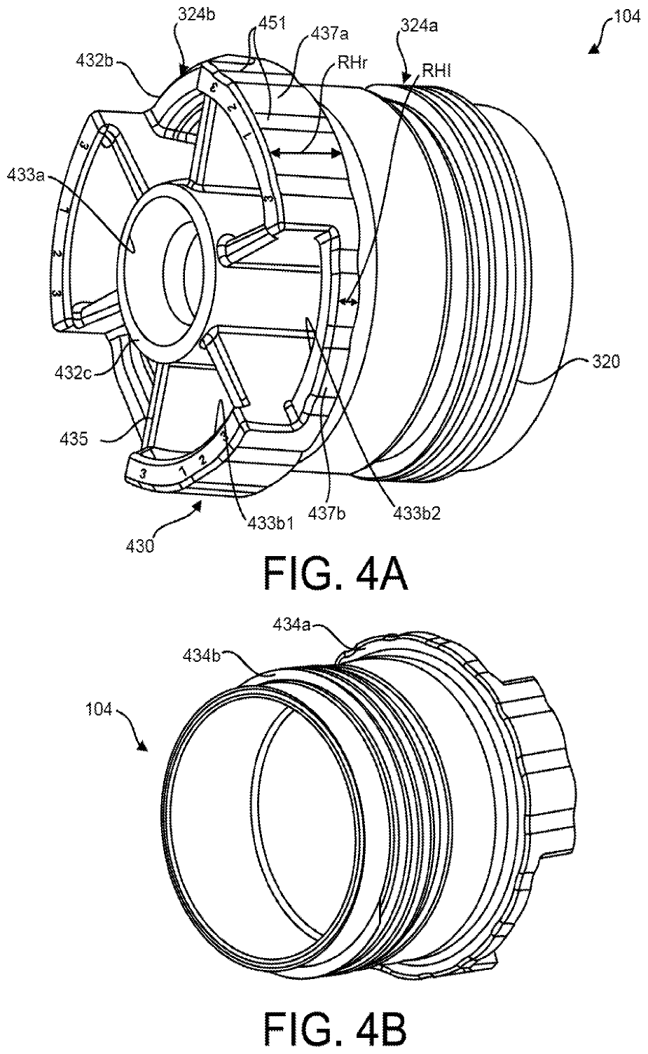

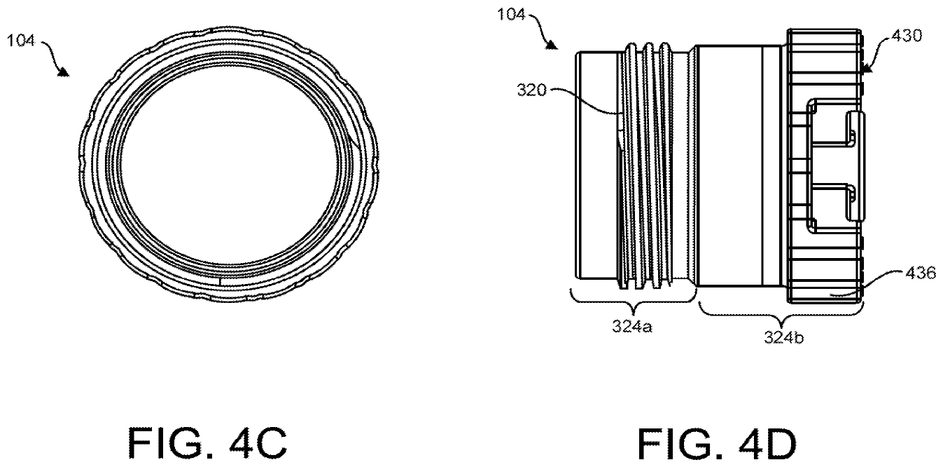

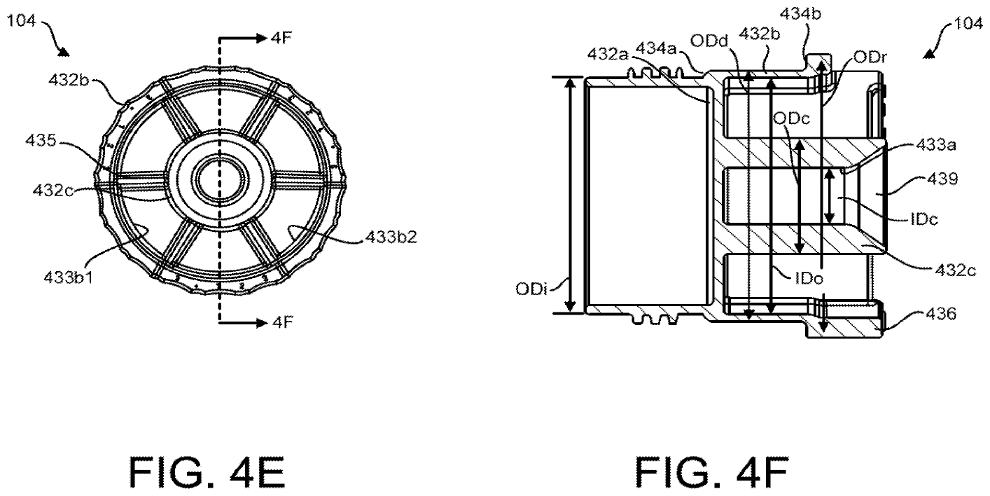

FIGS. 4A-4F are front perspective, rear perspective, front end, side, rear end, and cross-sectional views, respectively, of the thread protector 104. FIG. 4F is a cross-sectional view of the thread protector 104 taken along the line 4F-4F. These figures show the thread protector 104 in greater detail. As shown in these views, the thread protector 104 includes the insert portion 324a and the drive portion 324b. The insert portion 324a has a tubular shape with the threads 320 along an outer surface thereof. The insert portion 324a has an insert outer diameter ODᵢ. The threads 320 may have a pitch and length corresponding to the internal threads 322a of the threaded ends 110 of the tubular 102 for mated connection therebetween (FIG. 3).

The drive portion 324b may include a receptacle 430 having a bottom 432a, an outer ring 432b, and an inner ring 432c. The bottom 432a isolates the insert portion 324a from the drive portion 324b. The outer ring 432b defines the outer periphery of the drive portion 324b. The outer ring 432b has a drive outer diameter OD_{d}. The drive outer diameter OD_{d} is greater than the insert outer diameter ODᵢ of the threaded portion. A step 434a is defined between the drive outer diameter OD_{d} and the insert outer diameter ODᵢ.

The outer ring 432b also has a flanged rim 436 extending radially from the outer periphery of the drive portion 324b. The flanged rim 436 has a rim outside diameter ODᵣ. The rim outer diameter ODᵣ is greater than the drive outer diameter OD_{d}. A step 434b is defined between the rim outer diameter ODᵣ and the drive outer diameter OD_{d}. The flanged rim 436 also has ridges (griping surfaces) 451 radially dispersed about the outer periphery of the flanged rim 436.

The outer ring 432b has an inner diameter IDₒ. The inner ring 432c has an outer diameter OD_{c}. The inner diameter ODₑ of the inner ring 432c is smaller than the inner diameter IDₒ of the outer ring 432b. The inner ring 432c also has an inner diameter IDₑ. The inner diameter ID_{c} defines a central cavity 433a. The central cavity 433a has a tubular shape with an inwardly tapered opening 439. The tapered opening 439 defines a funnel shaped inlet.

The inner ring 432c is concentrically positioned within the outer ring 432b. A plurality of radial pockets 433b1,2 are radially disposed about the central cavity 433a between the inner ring 432c and the outer ring 432b. The radial pockets 433b1,2 are separated by spokes 435 extending between the inner ring 432c and the outer ring 432b. The spokes 435 may be linear walls extending radially from the inner ring 432c to the outer ring 432b. In the example shown, six (6) spokes 435 are provided to define six (6) corresponding radial pockets 433b1,b2.

Each of the radial pockets 433b1,2 has an inner portion defined by the inner ring 432c, side portions defined by the spokes 435, a rim portion 437a,b defined by the outer ring 432b and the rim 436, and a bottom portion defined by the bottom 432a. Three of the radial pockets 433b1 have the raised rim portion 437a, and three of the radial pockets 433b2 have the lowered rim portion 437b.

The raised rim portions 437a and the lowered rim portions 437b alternate radially about the outer ring 432b. The rim raised portion 437a has a raised rim height RHᵣ that is greater than a lower rim height RHₗ of the lowered rim portion 437b. The alternating rim heights RHᵣ, RHₗ define a raised portion and lower portion, respectively, of the receptacle 430 about the central cavity 433a. The central cavity 433a and the radial pockets 433b1,b2 combine to define a shape of the receptacle 430. This shape of the receptacle 430 is designed to receivingly correspond to the self-aligning bit 218 and to facilitate mating engagement therebetween as is described further herein.

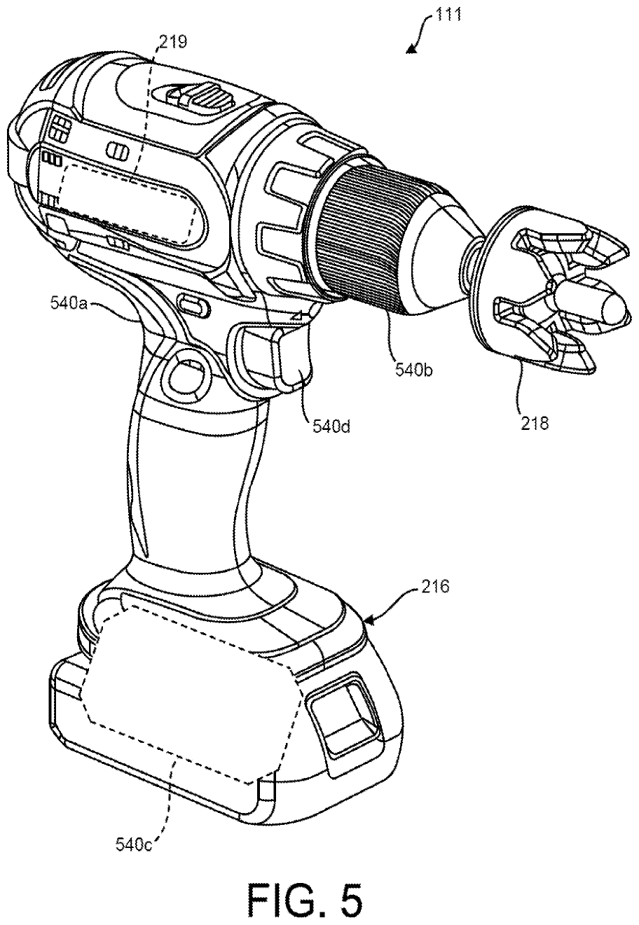

FIG. 5 is a perspective view of the alignable drive tool 111 with the self-aligning bit 218. As shown in this view, the driver 216 includes a base 540a, a chuck 540b, electronics 540c, activator (e.g., button) 540d, and the motor 219. The base 540a is shown as a handheld container for supporting the chuck 540b and for hosting the electronics 540c and the motor 219 therein. The chuck 540b may be a rotatable member movable between a grip (closed) position for supporting the self-aligning bit 218, and a release (open) position for removing the self-aligning bit 218. The electronics 540c may include, power (e.g., battery), control, and/or other devices coupled to the self-aligning bit 218 for rotation thereof. The electronics 540c may be coupled to the activator 540d for triggering rotation of the self-aligning bit 218. The driver 216 may also have other components in the base 540a to operate the self-aligning bit 218 as needed.

The self-aligning bit 218 is carried by the driver 216. The driver 216 may be moved, for example, by an operator (not shown) to position the self-aligning bit 218 about the thread protector 104 for use therewith (see, e.g., FIGS. 2A and 2B). The self-aligning bit 218 may be supported in position by the driver 216 for engagement with the thread protector 104. The self-aligning bit 218 may be selectively rotatable by the driver 216 as the self-aligning bit 218 is advanced into engagement or disengagement with the thread protector 104 as is described further herein.

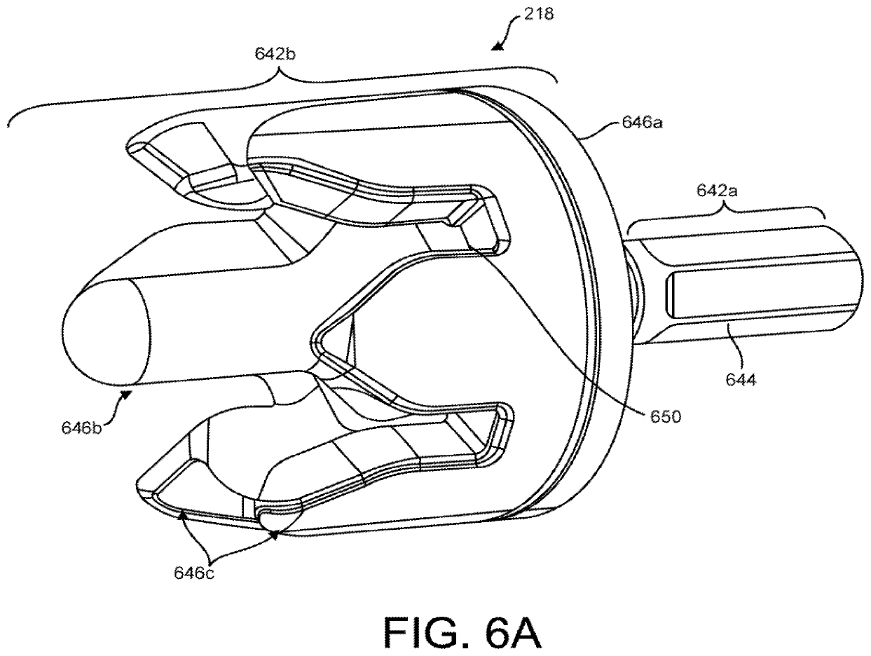

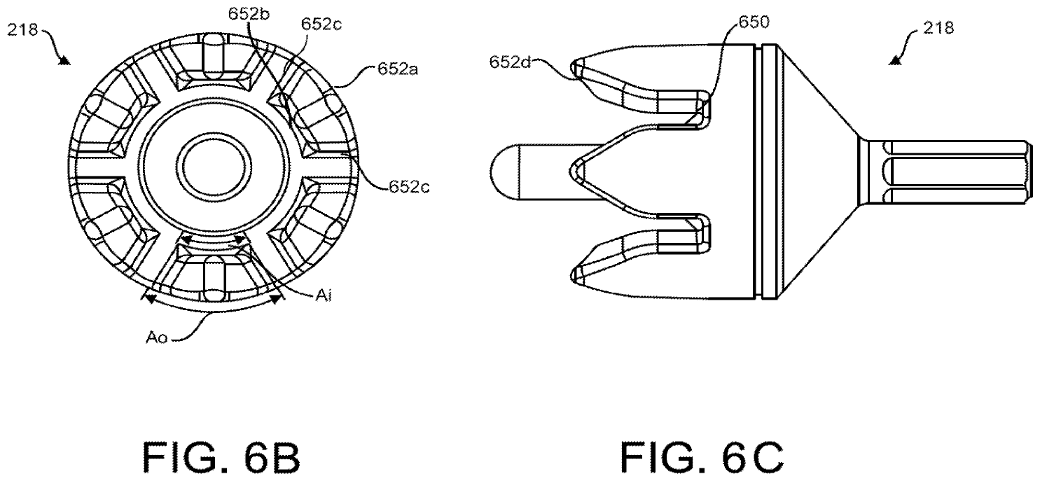

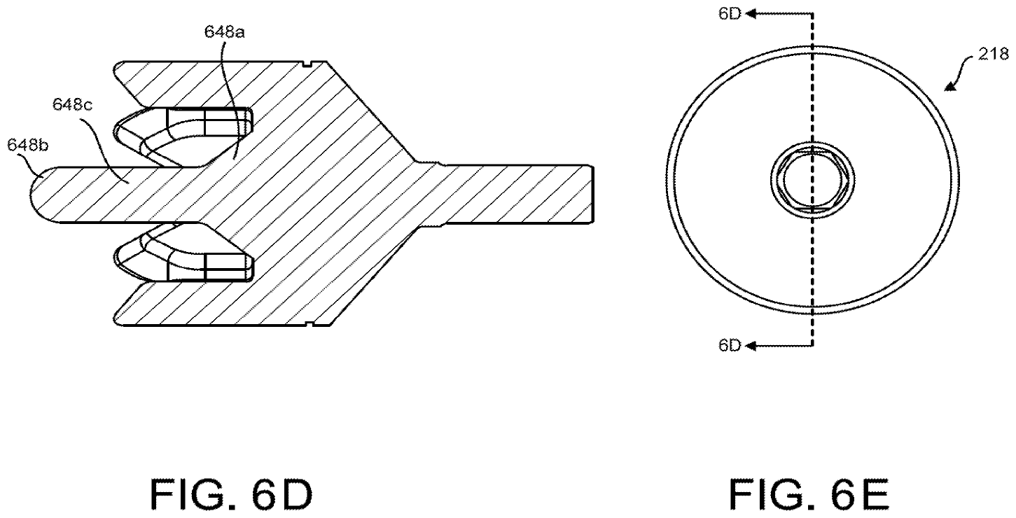

FIGS. 6A-6E are perspective, front end, side, cross-sectional, and rear end views of the self-aligning bit 218. FIG. 6D is a cross-sectional view of the self-aligning bit 218 of FIG. 6E taken along line 6E-6E. As shown in these views, the self-aligning bit 218 includes a chuck portion 642a and a plug portion 642b. The chuck portion 642a may be an elongate shaft 644 receivable in the chuck 540b of the driver 216 (FIG. 5). The elongate shaft 644 may be shaped for engagement with and/or rotation by the driver 216 during operation.

The plug portion 642b includes a platform 646a, a central hub 646b, and radial fingers 646c. The platform 646a is a circular member connected to the elongate shaft 644. The elongate shaft 644 extends axially from a central portion of the platform 646a (e.g., from a driven side of the platform 646a). The central hub 646b extends axially from an opposite side (e.g., driver side) of the platform 646a from the elongate shaft 644. The central hub 646b has a conical bottom 648a, a rounded tip 648b, and an elongate body 648c. The conical bottom 648a is positioned on the platform 646a. The conical bottom 648a may have an angled surface corresponding to (e.g., receivingly engagable in) the tapered opening 439 of the thread protector 104 (FIG. 4F).

The elongate body 648c is supported between the conical bottom 648a and the rounded tip 648b. The elongate body 648c of the central hub 646b may be axially aligned with the elongate shaft 644. The elongate body 648c may have a shape corresponding to the central cavity 433a of the thread protector 104 (FIG. 4F). The rounded tip 648b is positioned at an end of the elongate body 648c. The rounded tip 648b extends from the platform 646a a distance further than the radial fingers 646c.

The radial fingers 646c also extend from the platform 646a. The radial fingers 646c are positioned radially about a periphery of the platform 646a to encircle the central hub 646b. The radial fingers 646c are dispersed about the periphery of the platform 646a with a space 650 therebetween. Each of the radial fingers 646a has an outer surface 652a, an inner surface 652b, side surfaces 652c, and a tapered tip 652d.

The outer surface 652a has a curve shape with an outer arc Aₒ conforming to the outer periphery of the platform 646a. The inner surface 652b has a curved shape similar to the curved shape of the outer surface 652a, except that the inner surface 652b is a distance from the outer periphery with a shorter arc Ai than the outer arc Aₒ. The outer surface 652a may be shaped to conform to the inner surface of the outer ring 432b and the inner surface 652b may be shaped to conform to the outer surface of the inner ring 432c.

Each of the side surfaces 652c extends between opposite ends of the inner surface 652b and the outer surface 652a. The outer surface 652a, the inner surface 652b, and the side surfaces 652c each extend from the platform 646a and taper together until terminated at the tapered tip 652d. The tapered tip 652d is defined by tapered portions of the outer surface 652a, the inner surface 652b, and the side surfaces 652c. Adjacent pairs of the side surfaces 652c and the space 650 therebetween may be shaped to receive the spoke 435 therebetween.

The central hub 646b may be shaped for insertion into the central cavity 433a of the receptacle 430 (FIGS. 4A-4F). The rounded tip 648b may be shaped to facilitate such insertion. The radial fingers 646c may be shaped for insertion in the radial pockets 433b1,b2 of the receptacle 430 (FIGS. 4A-4F). The tapered tip 652d of the radial fingers 646c may be shaped to facilitate such insertion into the radial pockets 433b1,b2. The central hub 646b and the radial fingers 646c may be shaped to facilitate positioning and insertion of the self-aligning bit 218 into mating engagement with the thread protector 104 as is described further herein.

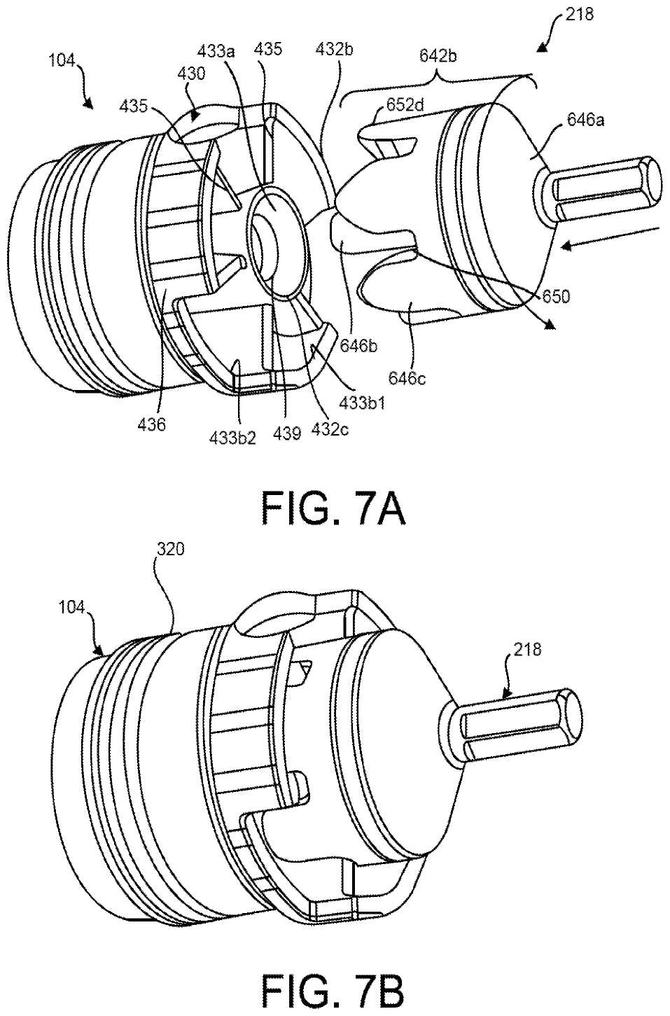

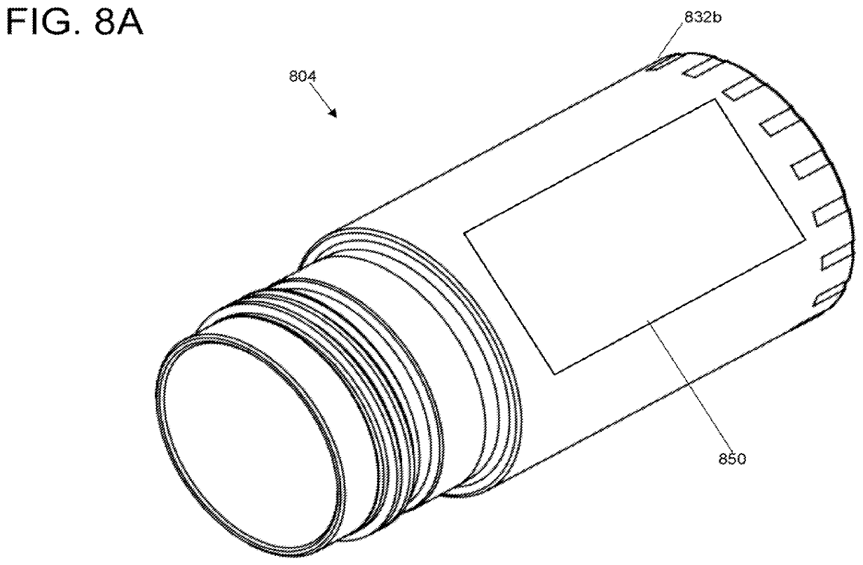

FIGS. 7A and 7B are perspective views of the thread protector 104 and the self-aligning bit 218 in the disengaged and the engaged position, respectively. As shown by these views, the self-aligning bit 218 may be aligned with the thread protector 104 as the self-aligning bit 218 is advanced into the thread protector 104. To facilitate insertion of the self-aligning bit 218 into the thread protector 104, the plug portion 642b of the self-aligning bit 218 is positioned face-to-face with the receptacle 430. The self-aligning bit 218 is advanced until the central hub 646b extends into the central cavity 433a. The tapered opening 439 of the inner ring 432c of the receptacle 430 and the rounded tip 648b (FIG. 6D) facilitate insertion of the central hub 646b into the central cavity 433a. With the central hub 646b positioned in the central cavity 433a, the self-aligning bit 218 is in an axially aligned position.

With the central hub 646b inserted in the central cavity 433a, the self-aligning bit 218 may rotate as it continues to advance into the receptacle 430. This may allow the radial fingers 646c to find and advance into corresponding radial pockets 433b1,b2. The tapered tips 652d of the radial fingers 646c may engage and slide along the spokes 435 as the radial fingers 646c advance into the radial pockets 433b1, b2. The rotation of the self-aligning bit 218 during advancement may allow the tapered tips 652d to slide along the spokes 435 and move to a centered position within the radial pockets 433b1, b2, thereby moving the self-aligning bit 218 into a radially aligned position. After alignment is met with the raised radial pockets 433b1, the self-aligning bit 218 may continue to advance to allow the other radial fingers 646c to enter the lowered radial pockets 433b2. Because three of the radial pockets 433b1 extend farther than the radial pockets 433b2, the radial fingers 646c may initially engage the three raised radial pockets 433b1 before engaging three lowered radial pockets 433b2.

As the radial fingers 646c advance, linear portions of the radial fingers 646c move into engagement with the portions of the outer ring 432b, the inner ring 432c, and the spokes 435 of the corresponding radial pockets 433b1, b2. In this position, the radial fingers 646c may fit snugly within the radial pockets 433b1, b2. The central hub 646b may also continue to advance until the conical bottom 648a fittingly engages the tapered opening 439. The platform 646a may also engage the front edges of the receptacle 430 about the tapered opening 439 and the rim 436. The radial fingers 646c may continue to advance until the self-aligning bit 218 is mated with the thread protector 104. This mating may occur, for example, when the rounded tip 648b engages the bottom 432a (FIG. 4F), and/or until the spokes 435 engage portions of the platform 646a along the space 650 between the radial fingers 646c.

With the self-aligning bit 218 fully advanced into the receptacle 430 of the thread protector, the self-aligning bit 218 is now in the engaged (mated) position as shown in FIG. 7B. Once properly engaged, the threads 320 self-aligning bit 218 may now be driven by the driver 216 into engagement and/or disengagement with the threads 322a of the tubular 102 for insertion into and/or removal from the tubular 102 (FIGS. 2A, 2B, 3).

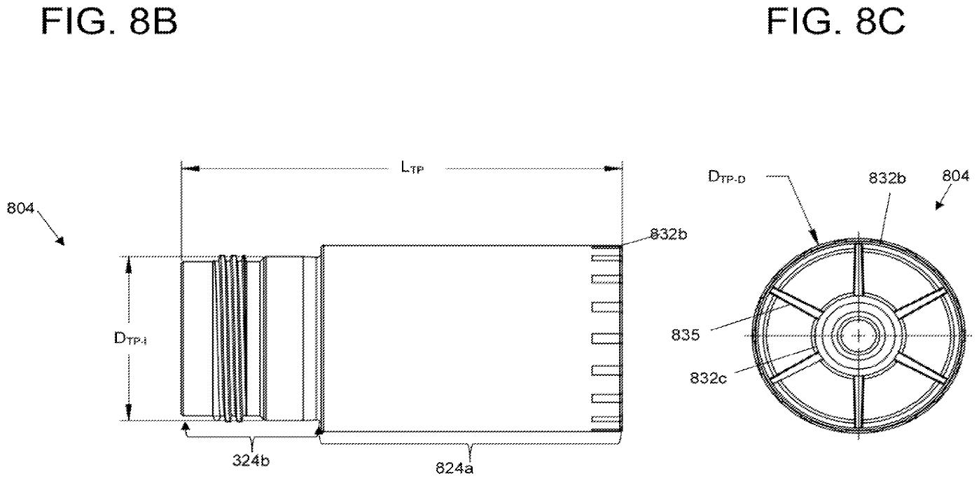

FIGS. 8A-8C are perspective, side, and end views, respectively, of another thread protector 804. As demonstrated by these views, the thread protector 804 may have other features and configurations. In this version, the thread protector 804 has a similar insert portion 324a as previously described in FIGS. 4A-4F, and a different drive portion 824a. The drive portion 824a also has different dimensions and a different shape.

In this version, the drive end 824a has a cylindrical shape with a smooth constant outer diameter D_{TP-D} (e.g., about 03.04 inches (7.72 cm)). This outer diameter D_{TP-D} is larger than the outer diameter D_{TP-I} (e.g., about 02.68 inches (6.81 cm)) of the insert portion 324a. The length L_{TP} of the drive end 824a has also been extended to about 6.59 inches (16.74 cm). This version also has no flanged rim 436 as shown in FIG. 4F, but optionally can be provided as needed.

The drive end 824a has an inner ring 832a concentrically positioned in an outer ring 832b with spokes 835 extending therebetween in a similar configuration to the inner ring 432a, outer ring 432b, and spokes 435, respectively, of FIGS. 4A-4F. In this version, the spokes 835 have a tapered shape that has a wider thickness adjacent the inner ring 832c and tapers down to a narrower thickness adjacent the outer ring 832b.

As also schematically shown in FIG. 8A, an identifier 850 may optionally be positioned about the thread protector 804. In the example shown in FIG. 8A, the identifier 850 is a label affixed (or attached to) the thread protector. In this example, the identifier 850 is shown as a rectangular item secured to an outer surface of the drive portion 824b. The drive portion 824a of the thread protector 804 has been elongated to provide sufficient space to apply the identifier 850. In this example, the overall length of the thread protector L_{TP} has been extended to about 6.59 inches (16.74 cm) to fit a label with required markings.

The identifier 850 may be affixed to the thread protector 804 at various locations and by various means. For example, the identifier 850 may be affixed to the thread protector 804 about the drive end for visibility outside of the tubular 102 (see, e.g., FIGS. 1, 2A, 2B). The identifier 850 may also be secured by an adhesive, tape, or other means. The identifier 850 label may include various information, such as product identification, reference numbers, material content, safety information, part number, materials, company information, unique identification, serial numbers, etc. The identifier 850 may include, for example, information relating to a product number, related equipment (type of compatible tool), company information (name and address), and a safety code (e.g., color-coded explosive symbol indicating that the tool has explosive material).

While a specific configuration of the thread protector 804 is depicted in FIGS. 8A-8C, it will be appreciated by one of skill in the art that the configuration of the thread protector 804 may vary, and the identifier 850 may have various configurations and may be secured in various positions about the thread protector 804. Other forms of identifier 850 and information of the identifier 850 may vary as needed with given applications.

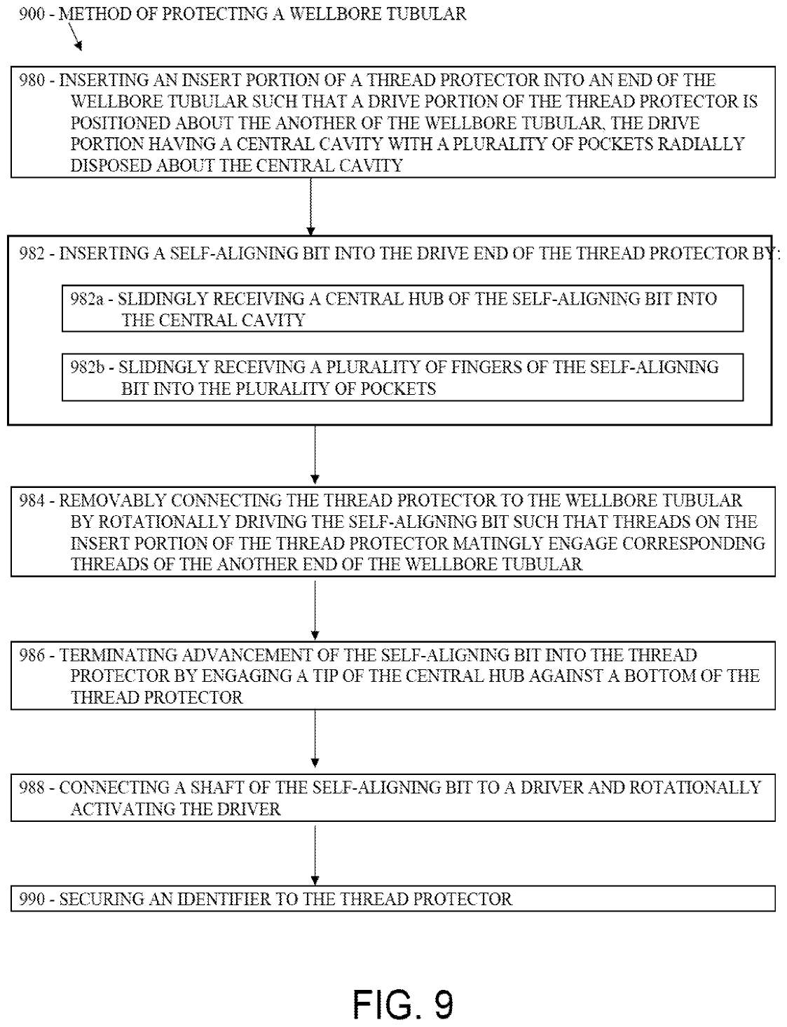

FIG. 9 is a flow chart of a method 900 of protecting a wellbore tubular. The method 900 comprises 980 inserting an insert portion of a thread protector into an end of the wellbore tubular such that a drive portion of the thread protector is positioned about the end of the wellbore tubular. The drive portion has a central cavity with a plurality of pockets radially disposed about the central cavity. The method 980 continues with 982 inserting a self-aligning bit into the drive portion of the thread protector by: 982a slidingly receiving a central hub of the self-aligning bit into the central cavity; and 982b slidingly receiving a plurality of fingers of the self-aligning bit into the plurality of pockets. The method 980 further continues with 984 removably connecting the thread protector to the wellbore tubular by rotationally driving the self-aligning bit such that threads on the insert portion of the thread protector matingly engage corresponding threads of the end of the wellbore tubular.

The method 900 may also involve 986—terminating advancement of the self-aligning bit into the thread protector by engaging a tip of the central hub against a bottom of the thread protector, 988—connecting a shaft of the self-aligning bit to a driver and rotationally activating the driver, and 990—securing an identifier to the thread protector.

Part or all of the method 900 may optionally be repeated or performed in any order. For example, the method 900 may also involve repeating the method 900 for another end of the same wellbore tubular and/or one or more wellbore tubulars.

This description of preferred embodiments is to be read in connection with the accompanying drawings, which are part of the entire written description of this invention. In the description, corresponding reference numbers are used throughout to identify the same or functionally similar elements. Relative terms such as “horizontal,” “vertical,” “up,” “upper”, “down,” “lower”, “top”, “bottom”, “anterior” and “posterior” as well as derivatives thereof (e.g., “horizontally,” “downwardly,” “upwardly,” etc.) should be construed to refer to the orientation as then described or as shown in the drawing figure under discussion. These relative terms are for convenience of description and are not intended to require a particular orientation unless specifically stated as such. Terms including “inwardly” versus “outwardly,” “longitudinal” versus “lateral” and the like are to be interpreted relative to one another or relative to an axis of elongation, or an axis or center of rotation, as appropriate. Terms concerning attachments, coupling and the like, such as “connected” and “interconnected,” refer to a relationship wherein structures are secured or attached to one another either directly or indirectly through intervening structures, as well as both movable or rigid attachments or relationships, unless expressly described otherwise. The term “operatively connected” is such an attachment, coupling or connection that allows the pertinent structures to operate as intended by virtue of that relationship.

While the embodiments are described with reference to various implementations and exploitations, it will be understood that these embodiments are illustrative and that the scope of the inventive subject matter is not limited to them. Many variations, modifications, additions and improvements are possible. For example, various combinations of one or more of the features and/or methods provided herein may be used.

Plural instances may be provided for components, operations or structures described herein as a single instance. In general, structures and functionality presented as separate components in the exemplary configurations may be implemented as a combined structure or component. Similarly, structures and functionality presented as a single component may be implemented as separate components. These and other variations, modifications, additions, and improvements may fall within the scope of the inventive subject matter. For example, while certain tools and components (e.g., assemblies) are provided herein, it will be appreciated that various configurations (e.g., shape, order, orientation, etc.) of such tools and/or components may be used. While the figures herein depict a specific configuration or orientation, these may vary. First and second are not intended to limit the number or order.

Insofar as the description above and the accompanying drawings disclose any additional subject matter that is not within the scope of the claim(s) herein, the inventions are not dedicated to the public and the right to file one or more applications to claim such additional invention is reserved. Although a very narrow claim may be presented herein, it should be recognized the scope of this invention is much broader than presented by the claim(s). Broader claims may be submitted in an application that claims the benefit of priority from this application.

What is claimed is:

1. A thread protection system for a wellbore tubular, comprising:
a thread protector having an insert portion at one end and a drive portion at an opposite end, the insert portion engageable with an end of the wellbore tubular, the drive portion having a central cavity axially positioned about the thread protector and a plurality of pockets radially disposed about the central cavity; and
a self-aligning bit comprising a platform with a central hub and a plurality of fingers extending perpendicularly from a driven side of the platform, the plurality of fingers radially disposed about the central hub, the central hub slidingly receivable in the central cavity, the plurality of finger having tapered tips slidingly receivable into the plurality of pockets;
wherein the self-aligning bit is rotationally drivable by a driver whereby the thread protector is removably connectable to the wellbore tubular.

2. The thread protection system of claim 1, wherein the insert portion is receivingly positionable in the end of the wellbore tubular.

3. The thread protection system of claim 1, wherein the insert portion has insert threads mateably connectable to threads on the wellbore tubular.

4. The thread protection system of claim 1, wherein, when the insert portion is connected to the end of the wellbore tubular, the drive portion extends from the end of the wellbore tubular.

5. The thread protection system of claim 1, wherein the insert portion has an inner ring and an outer ring, the inner ring concentrically positioned within the outer ring.

6. The thread protection system of claim 5, wherein the inner ring has a tapered opening with the central cavity therein shaped to slidingly receive the central hub of the self-aligning bit.

7. The thread protection system of claim 5, wherein the plurality of pockets are defined between the inner ring and the outer ring, each of plurality of the pockets being separated by spokes extending radially between the inner ring and the outer ring.

8. The thread protection system of claim 7, wherein the plurality of pockets comprises raised pockets and recessed pockets.

9. The thread protection system of claim 8, wherein the outer ring has raised portions about the raised pockets and recessed portions about the recessed pockets.

10. The thread protection system of claim 1, wherein the drive portion has a bottom separating the drive portion from the insert portion.

11. The thread protection system of claim 1, wherein the central hub is an elongate member with a tapered bottom at a first end and a rounded tip at a second end, the tapered bottom extending from the platform.

12. The thread protection system of claim 1, wherein the plurality of fingers are radially dispersed about the platform with a space between each adjacent pair of the plurality of fingers.

13. The thread protection system of claim 1, wherein each of the tapered tips are of each of the plurality of fingers is shaped for insertion into a corresponding one of the plurality of pockets.

14. The thread protection system of claim 1, wherein the self-aligning bit further comprises an elongate shaft extending axially from a driver side of the platform.

15. The thread protection system of claim 14, wherein the elongate shaft is rotationally connectable to the driver.

16. A thread protection system for a wellbore tubular, comprising:
a thread protector having an insert portion at one end and a drive portion at an opposite end, the insert portion engageable with an end of the wellbore tubular, the drive portion having a central cavity axially positioned about the thread protector and a plurality of pockets radially disposed about the central cavity; and
an alignable drive tool, comprising:
a self-aligning bit comprising a platform with a central hub and a plurality of fingers extending perpendicularly from a driven side of the platform, the plurality of fingers radially disposed about the central hub, the central hub slidingly receivable in the central cavity, the plurality of finger having tapered tips slidingly receivable into the plurality of pockets; and
a driver rotationally connectable to the self-aligning bit and drivable thereby whereby the thread protector is removably connectable to the wellbore tubular;
wherein, while the central hub is positioned in the central cavity and the self-aligning bit advances into the drive portions, the tapered tips of the plurality of fingers slidingly engage the plurality of pockets and center the plurality of fingers within the plurality of pockets.

17. The thread protection system of claim 16, wherein the driver comprises a motor.

18. The thread protection system of claim 16, further comprising an identifier secured to the thread protector.

19. A method of protecting a wellbore tubular, comprising:
inserting an insert portion of a thread protector into an end of the wellbore tubular such that a drive portion of the thread protector is positioned about the end of the wellbore tubular, the drive portion having a central cavity with a plurality of pockets radially disposed about the central cavity;
inserting a self-aligning bit into the drive portion of the thread protector by:
slidingly receiving a central hub of the self-aligning bit into the central cavity; and
slidingly receiving a plurality of fingers of the self-aligning bit into the plurality of pockets; and
removably connecting the thread protector to the wellbore tubular by rotationally driving the self-aligning bit such that threads on the insert portion of the thread protector matingly engage corresponding threads of the end of the wellbore tubular.

20. The method of claim 19, further comprising:
inserting the insert portion of another thread protector into another end of the wellbore tubular such that the drive portion of the another thread protector is positioned about the another end of the wellbore tubular, the drive portion having the central cavity with the plurality of pockets radially disposed about the central cavity;
inserting the self-aligning bit into the drive portion of the another thread protector by:
slidingly receiving the central hub of the self-aligning bit into the central cavity of the another thread protector; and
slidingly receiving the plurality of fingers of the another self-aligning bit into the plurality of pockets of the another thread protector; and
removably connecting the another thread protector to the wellbore tubular by rotationally driving the self-aligning bit such that threads on the insert portion of the self-aligning bit matingly engage corresponding threads of the another end of the wellbore tubular.

21. The method of claim 19, further comprising terminating advancement of the self-aligning bit into the thread protector by engaging a tip of the central hub against a bottom of the thread protector.

22. The method of claim 19, further comprising connecting a shaft of the self-aligning bit to a driver and rotationally activating the driver.

23. The method of claim 19, further comprising securing an identifier to the thread protector.
